(19) United States
(12) Patent Application Publication
(10) Pub. No.: US 2009/0185481 A1
(43) Pub. Date: Jul. 23, 2009

(54) METHOD AND NETWORK NODE FOR SELF-REGULATING, AUTONOMOUS AND DECENTRALIZED TRAFFIC DISTRIBUTION IN A MULTIPATH NETWORK

(75) Inventors: Stefan Butenweg, Muenchen (DE); Claus Gruber, Muenchen (DE); Thomas Schwabe, Muenchen (DE)

Correspondence Address: K&L Gates LLP, P.O. BOX 1135, CHICAGO, IL, 60690, US

(73) Assignee: Nokia Siemens Networks GmbH & Co KG, Muenchen (DE)

(21) Appl. No.: 12/406,748

(22) Filed: Mar. 18, 2009

Related U.S. Application Data
(63) Continuation of application No. 10/556,830, filed on Nov. 15, 2005, now abandoned.

(30) Foreign Application Priority Data
May 15, 2003 (DE) 103 21 953.6

(51) Int. Cl. H04J 3/14; H04J 1/16

(52) U.S. Cl. 370/218; 370/235

(57) ABSTRACT

According to one embodiment, traffic load is redirected in reaction to traffic overload or a link failure in a packet-based network that is formed by nodes and links, packets being distributed along multiple paths to other links of an associated array of paths. The redistribution is performed autonomously by the node which is located immediately upstream of the affected link. According to a further development of the method, nodes that are located upstream of the concerned node are notified and are made to perform a redistribution that relieves the concerned node if the array of paths is not made overload-free by the redistribution performed by the node. A mechanism that protects against overload and failures and reacts in a significantly more flexible and less error-prone manner than networks having a central control body due to the nodes being autonomous is provided.

### CROSS REFERENCE TO RELATED APPLICATIONS

This application is a continuation of, claims priority to, and claims the benefit of U.S. patent application Ser. No. 10/556,830 filed on Nov. 15, 2005, in which 10/556,830 is a 371 of International Application No. PCT/EP2004/050782, filed May 13, 2004 and claims the benefit thereof. The International Application claims the benefits of German Application No. 10321953.6 DE filed May 15, 2003, both of the applications are incorporated by reference herein in their entirety.

### BACKGROUND

The invention relates to a method for redistributing traffic in response to a traffic overload or a link failure and a node for a packet-based network with multipath distribution.

Possibly the most important development at present in the field of networks is the development of new technologies to make packet-oriented data networks and thereby primarily the internet suitable for new services. These new services relate primarily to so-called real-time traffic, eg. voice data and video data.

The success of the internet as the most widely used medium for sending or transmitting data is largely due to its flexibility. IP (Internet Protocol) technology is used for so-called destination based routing. IP packets contain an origin address and a destination address, based on which local routing decisions are made. This is also referred to as routing on a per hop basis, in other words routers forward to a subsequent node (next hop) based on the destination address specified in the data packet. Conventional IP technology has the significant advantage that states do not have to be maintained in the network and paths do not have to be determined beforehand for the transmission of data packets. This has to be offset against the disadvantage that the packets can only be switched on a “best effort” basis, i.e. there is no guarantee of quality of service.

The most commonly used routing protocol for an autonomous network domain or autonomous system at present is the so-called OSPF (Open Shortest Path First) protocol, which utilizes a distributed routing approach. The topology of the network is thereby known to the every node and is distributed by so-called link state advertisement messages to all the nodes in the network. The shortest path in each instance is calculated autonomously in every node for all the destinations known to said node based on link metrics. Link failure results in re-calculation of the paths.

Two main approaches are followed to improve the quality of service of IP networks in respect of new services with quality of service requirements. With one approach more than one path is established between a source and a drain or an origin and a destination, in order to be able to respond to bottleneck situations or fault situations by distribution via different paths. The routing protocol OSPF has been extended to this end by introducing the Equal Cost Multipath (ECMP) concept, which allows the simultaneous use of a number of paths of equal length, in the sense of a metric, between a source and a drain. The method makes it possible to distribute the traffic to paths of the same length. An extension of this concept can be understood to be the optimization of link usage based on measured or calculated network loads using traffic engineering mechanisms, i.e. mechanisms to control and regulate the packet traffic. The so-called OSPF-TE (TE: Traffic Engineering) method tries to allow regular distribution of the traffic in the network by adjusting the link metrics distributed in the network as a function of the usage of the respective link. The multipath routing methods are typically based on a central load distribution calculation, i.e. a decision is made at a central point or by a central entity about how the packets should be distributed.

The second approach is the central determination of paths through the network along with permanent reservation of the required bandwidth. The most important concept, involving the switching of paths, is the so-called Multi Protocol Label Switching (MPLS) protocol or concept. Virtual paths through the network are defined in the context of this concept. Incoming packets are allocated to virtual paths at the input router of an MPLS domain. Appropriate global selection of the paths and the assignment of packets to the paths allow regular distribution in the network.

Such approaches to improving the transmission quality of conventional data networks to some extent at least cancel out the advantages of conventional data networks, namely their flexibility and low level of complexity.

### SUMMARY

An object of the invention is to specify a method for multipath routing, with which traffic distribution or load distribution is optimized whilst avoiding the disadvantages of conventional methods.

The method is based on a packet-based network, in which there is provision for multipath routing or the distribution of packets to different paths. The network is made up of nodes and links (also referred to as edges or connection segments). It is possible, for some of the nodes at least, to send incoming packets to their destination on a number of different paths. The term array of paths or distribution array is used below for the different alternatives or different options for a node to forward a data packet to a subsequent link as a function of the destination of the data packet. The array of paths for a node in respect of a destination comprises the links out of the node, via which packets can be routed to the destination. The paths to the destination do not necessarily have the same length in the sense of a metric. A destination is generally defined by the routing criterion for the individual nodes specified in a routing table. This is not necessarily identical to the destination address generally specified in the packet but can, for example, comprise part of the destination address. In the case of IP networks the nodes or routers generally use the part of the address describing the network, in which the IP network end point (e.g. host gateway) is located, which corresponds to the full destination address of the packet.

According to the invention, nodes in the network independently or autonomously distribute the packets or the load to the links of an array of paths. This load distribution is also changed autonomously by the nodes. A node monitors the traffic load or packet rate it routes to a link. If an overload occurs in a link, this is detected by the node and an overload protection measure is then initiated. The primary overload protection measure is to redistribute traffic from the overloaded link to other links in the associated array of paths. A response to a link failure by redistributing to links of the associated array of paths that have not failed can be provided for correspondingly.

The invention has the advantage that the overload protection response by the node is autonomous, i.e. redistribution takes place locally. There is no need for a complex signaling operation or the propagation of messages through the entire network of nodes, which would very significantly increase the complexity of the routing protocol. Nor is there a need for a central entity, either for control purposes or to determine weightings if node weightings should have to be recalculated. Instead the weightings for routing purposes along an array are once again determined by the respective nodes. A central control entity is a weak point in respect of any fault in said entity and this is avoided in the present invention.

The inventive redistribution or allocation of the traffic to different paths can be infinite in the sense that any allocation ratios of packets to links of an array of paths are possible. This contrasts with various current multipath routing methods (e.g. ECMP), which specify a fixed allocation ratio. Optimum allocation ratios can for example be determined using the traffic matrix, i.e. the measured or calculated traffic loads on the links. Alternatively it is possible to optimize allocation ratios by means of a control process. The modified link loads in the event of traffic redistribution are thereby related to the traffic redistribution measures and the distribution measures to avoid overload situations are thereby determined.

According to one development, load redistribution is carried out by the individual nodes or by one individual node in stages. No further traffic redistribution measures are thereby implemented after the end of a stage during a waiting period or a time interval. After the end of the time interval any next stage that may be required for traffic redistribution is started. This allows the nodes following after a node initiating a protection measure to resolve any overload resulting at them due to the redistribution and to redistribute the traffic in turn. Also gradual load adjustment counteracts system oscillation.

The subject matter of the invention can be developed for situations, in which the overload cannot be resolved by redistribution within an array or if a link fails the data packets cannot be distributed to the other links of the associated array of paths, without generating an overload on one of these links. To this end an overloaded node sends a message to one node upstream from it at least, prompting said node to carry out a redistribution operation for its part, such that fewer data packets are transmitted to the node in question. Upstream thereby relates to the paths of the packets distributed on the distribution arrays affected by the overload or link failure. This method can be extended recursively or in a cascaded fashion to the upstream nodes in front of the node in question, such that every node that receives a message requesting redistribution but cannot achieve this by redistribution within the array or arrays for its part sends messages to nodes upstream from it, so that these for their part reduce the traffic by redistribution. It is thereby expedient for a message prompting redistribution to contain information about the required traffic reduction, e.g. its nature and scope. This method generally reaches a limit when an edge node in the network receives a message to reduce the overload. For edge nodes can generally not communicate with nodes in another network using the protocol used within the network to transmit messages. To reduce the traffic going away from it, such an edge node can reduce the traffic it allows into the network as part of a network access control, to bring about the required traffic load reduction in this fashion. Access controls are frequently used in data networks, which are intended to ensure transmission in compliance with quality of service features.

The subject matter of the invention also includes a network node or router, which is equipped [with means to identify] a traffic overload and to redistribute traffic to other links going out from nodes. Such a node can also be provided with means to send messages, said messages being able to bring about traffic redistribution in upstream nodes. These means for example include software modules, which support the protocol used to send the messages.

Additional features and advantages are described herein, and will be apparent from the following Detailed Description and the figures.

### BRIEF DESCRIPTION OF THE FIGURES

The subject matter of the invention is described in more detail below based on an exemplary embodiment with reference to two figures, in which:

FIG. 1 shows a network segment with nodes and links

FIG. 2 shows an associated table with details of distribution arrays assigned to the nodes shown in the network segment.

### DETAILED DESCRIPTION

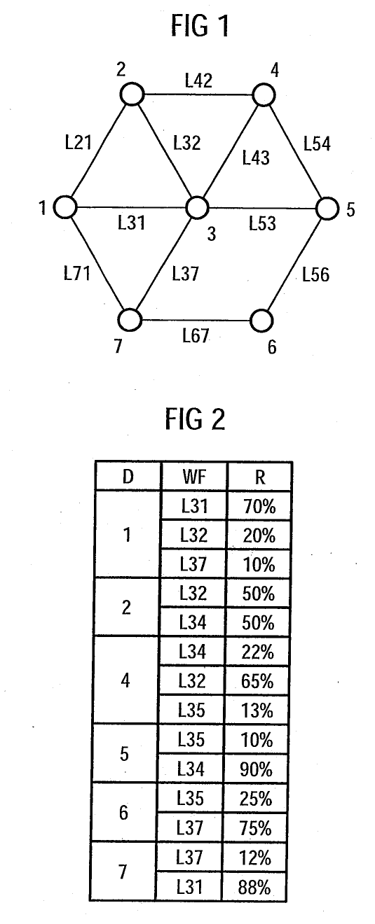

FIG. 1 shows nodes 1 to 6 and links (connections between the nodes) LIJ, I, J out from (1, 2, 3, 4, 5, 6, 7). A direction is thereby assigned to a link. For example the link L31 goes from the node 3 to the node 1. The overall traffic on the associated physical link between the nodes 3 and 1 is therefore made up of the traffic on the link L31 and the link L13, if there is provision for sending packets from the node 1 to the node 3. For the sake of simplicity links are only shown with one direction in the figure. FIG. 2 shows a table with different arrays of paths going out from the node 3. The first column D shows the destination or drain of packets forwarded from the node 3. For simplicity it is assumed that each of the other nodes shown is a possible destination for the packets sent. The second column shows the arrays of paths WF to the respective destinations. For example an array comprising three links is defined to the destination defined by the node 1, one link leading directly to the node 1 and the other two respectively via the nodes 2 and 7. The distribution ratio R or load distribution on these distribution arrays or arrays of paths is shown in the third column of the table. 70% of the traffic is thus routed directly to the node 1, while the other 30% is sent via the node 2 or the node 7 to its destination, the node 1. The distribution arrays to the nodes 2, 4, 5, 6 and 7 are shown in a similar fashion. The distribution ratio was determined according to the path priorities, with direct links having a higher distribution weighting. If the link L31 between the node 3 and the node 1 now fails, according to the invention the node 3 can distribute the traffic to the node 1 via the nodes 2 and 7 by changing the distribution weightings accordingly. As the majority of the traffic was sent via the link L13 between the node 1 and the node 3, redistribution can cause an overload on the links L37 between the node 3 and the node 7 and L32 between the node 3 and the node 2. To reduce this overload, the node 3 sends a message to the node 4 and the node 5, to reduce the traffic routed to it. On receipt of this message the nodes 4 and 5 change their traffic distribution for packets to the destination defined by the node 1. For example the node 5 routes a larger proportion of the traffic to the node 1 via the nodes 6 and 7 instead of via the node 3. And the node 4 increases the proportion of traffic routed via the node 2 to the node 1. This results in a reduction of the load on the links L37 and L32 between the nodes 3 and 7 and 3 and 2, in that upstream nodes, namely 5 and 4, route more traffic via the links L54, L42, and L21, as well as L56, L67 and L71. In actual networks with very many more nodes, the node 5 would generally have a node upstream from it, to which it could in turn send a message, if the measure taken by it would not result in the necessary reduction in traffic volume.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for redistributing traffic in response to a traffic overload or link failure in a packet-based communication network, the packet-based network having a first node and a link with multipath distribution of packets, with at least two outward links assigned to an array of paths, the outward links capable of distributing the packets having the same destination, comprising:
determining by the first node when a traffic load on a first outward link exceeds a limit or the link fails;
redistributing the traffic load, via the first node, independently of the external control entities, by routing at least some of the packets, which would have been routed via the first outward link had the load distribution not been changed, to a second outward link assigned to the same array of paths as the first outward link; and
sending a message to a upstream node to reduce the traffic load sent to the first node by the upstream node that would be distributed via the arrays of paths via the first node, the upstream node upstream in respect of the packets distributed via the arrays of paths, sending the message if the traffic load does not drop below the limit as a result of the traffic redistribution without a different limit being exceeded.

2. The method according to claim 1, wherein the traffic load redistribution is separated into a first stage and a next stage, and the initiation of the next stage is started at a time after the end of the first stage.

3. The method according to claim 2, wherein a message is sent to the upstream node for traffic redistribution at the upstream node, the message notifying to the upstream node to reduce traffic that would be distributed via the arrays of paths via the first node

4. The method according to claim 3, wherein the message includes information about the traffic load reduction.

5. The method according to claim 4, wherein the notified upstream node sends a message to a further upstream node for traffic redistribution at the further upstream node, the message sent when the notified upstream node cannot achieve the traffic load reduction for the first node via traffic load redistribution without causing a further upper limit for a traffic load to be exceeded.

6. The method according to claim 5 wherein the upstream node upstream node reduces the traffic load according to the message received or sends a message to the further upstream node to reduce the traffic load.

7. The method according to claim 6, wherein the upstream node, which receives the message to reduce the traffic load, is an edge node, the edge node reduces the load by reducing the limits for controlling an access to the network.

8. A node for a packet-based network with multipath distribution, comprising:
a distribution array including a first outward link and a second outward link;
a traffic overload identifier that identifies traffic overload on the first outward link;
a redistributor that redistributes traffic to the second outward link; and
a transmitter for sending a message to a upstream node to reduce the traffic load sent to the node by the upstream node that would be distributed via the arrays of paths via the node, the upstream node upstream in respect of the packets distributed via the arrays of paths, sending the message if the traffic load does not drop below the limit as a result of the traffic redistribution without a different limit being exceeded.

9. The node according to claim 8, further comprising a receiver for receiving a message to reduce the traffic load in, a downstream node.
